(19) United States
(12) Patent Application Publication
(10) Pub. No.: US 2002/0093898 A1
(43) Pub. Date: Jul. 18, 2002

(54) CD walkman adaptable for large and small compact disks

(76) Inventor: Hsi Kuang Ma, Taipei (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/775,581

(22) Filed: Feb. 5, 2001

(30) Foreign Application Priority Data
Jan. 12, 2001 (TW) 90200613

(51) Int. Cl. G11B 33/02

(52) U.S. Cl. 369/75.1

(57) ABSTRACT

A CD walkman adaptable for large and small compact disks comprises a base, a small upper cover, and a large upper cover. The base provides a reading and audio device therein, an upper flap being attached to an upper part of the rear end thereof. Engaging pieces are provided at the edge of upper flap. The small upper cover has a size corresponding to the base and provides a recess part corresponding to the upper flap. Engaging pieces are provided at a border surrounding the first recess part. The large upper cover provides a recess part corresponding to the upper flap, and engaging pieces are provided at a border surrounding the recess part. The engaging pieces on the small upper cover engages with engaging pieces on the upper flap and makes the small upper cover as an upper protection for the small CD in operation. The engaging pieces on the large upper cover engages with the engaging pieces on the upper flap and makes the large upper cover as an upper protection for the large CD in operation.

### BACKGROUND OF THE INVENTION

1. Field of The Invention

The present invention relates to a CD walkman adaptable for large and small compact disks, and particularly to a wearable CD player suitable for playing with either a large or a small compact disk (CD).

2. Description of Related Art

A WALKMAN is a very private audio device and it has a history of progress from utilizing a cassette tape to a compact disk (CD). There is a tendency that the size and the weight thereof have been developed toward lightness, thinness, shortness, and smallness. Nowadays, the CD walkman is the most popular and loved by teenagers and young people.

As for the medium, the cassette tape was used at the beginning and then the CD was developed afterward. Because the technique of zipping and unzipping data is applied to CD making, it leads to a development of smaller sized CD. Thus, a small CD walkman with high mobility is made to accommodate with the small CD and the principle of actuation with regard to data reading and sound output thereof is the same as a large CD walkman.

Because it is less option for users to select the small CD comparing to the large CD, it results in that the small CD is not so popular as the large CD. Especially, the large CD is much versatile after a long period of popularity so that a broader option can be selected naturally. Moreover, if the small CD walkman were developed, it would be too bad that the original large CD became useless.

There is a problem for a small CD walkman loading a large CD that a part of large CD extrudes beyond the entire unit of small CD walkman without any protection. The exposed part of large CD without concealment makes us scruple the safety thereof naturally.

The inventor has endeavored in overcoming the defect resided in the prior art and has filed U.S. patent application No. 09/689,791 entitled “A PORTABLE PLAYER SUITABLE FOR LARGE COMPACT DISKS AND SMALL COMPACT DISKS”.

In order to have multiple choices for the consumers, the inventor has investigated continuously and developed the present invention with regard to a CD walkman adaptable for large and small compact disks.

### SUMMARY OF THE INVENTION

An object of the present invention is to provide a CD walkman adaptable for large and small compact disks, with which a single base thereof can commonly used for a large CD and a small CD respectively to expand the function of the CD walkman effectively.

### BRIEF DESCRIPTION OF THE DRAWINGS

The present invention can be more fully understood by referring to the following description and accompanying drawings, in which:

FIG. 1 is an exploded perspective view of a CD walkman adaptable for a large and a small CDs according to the present invention;

FIG. 2 is a perspective view illustrating a small upper cover in the CD walkman of present invention being arranged for loading a small CD;

FIG. 3 is a perspective view illustrating a large upper cover in the CD walkman of present invention being arranged for loading a large CD; and

FIG. 4 is a perspective view illustrating a base in the CD walkman of present invention being added a lower cover and a large upper cover.

### DETAILED DESCRIPTION OF THE PREFERRED EMBODIMENTS

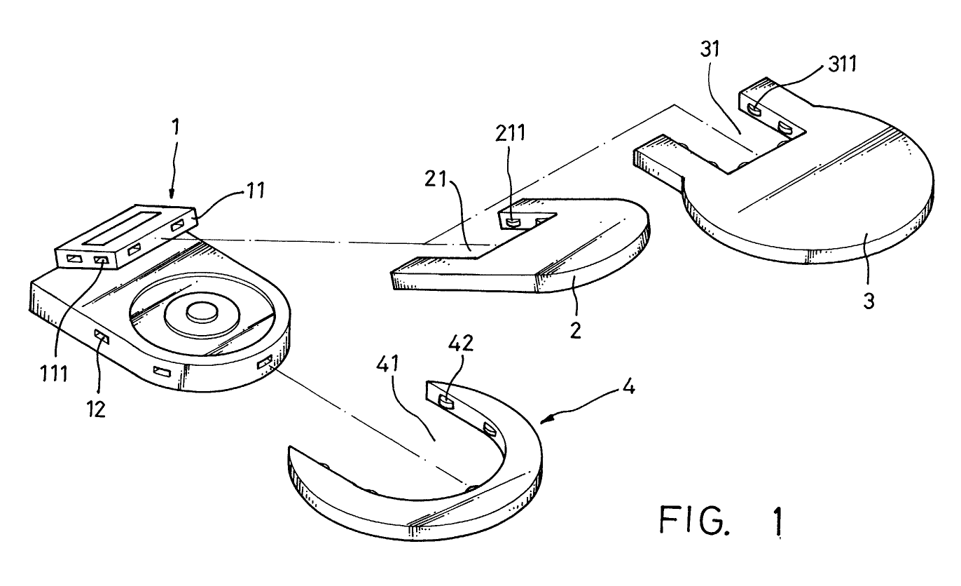

Referring to FIG. 1, basically, a CD walkman adaptable for large and small compact disks of present invention comprises a base 1, a small upper cover 2, a large upper cover 3, and/or a lower cover 4.

Wherein, the base 1 provides a conventional structure with related components therein and a post and a reading head at the top thereof for a CD being loaded thereon. The size of base I is corresponding to the small CD, that is, the base 1 is preferably has a greater size than that of the small CD. Moreover, a front end of the base 1 is semicircular shape, however, the semicircular shape is only an explanatory example not a restriction.

The base 1 of the present invention differentiates from the prior art in that an upper flap 11 is attached to the base 1 at the top thereof by way of such as hinges so as to be lifted pivotally. As the embodiment illustrated in FIG. 1, the upper flap 11 is rectangular and provides engaging pieces 111 such as projections, recesses, grooves, or other equivalent devices on the periphery thereof at least at two lateral sides for joining the upper cover 2. The base 1 at the surrounding edge thereof provides engaging pieces 12 such as projections, recesses, grooves, or other equivalent parts for engaging with the lower cover 4. As the embodiment illustrated in FIG. 1, the engaging pieces 12 are recesses and provided at the front and two lateral sides thereof to perform a better effect of engagement.

The small upper cover 2 is provided with a shape of plate and preferably has a thickness corresponding to the thickness of upper flap. Furthermore, the contour of small upper cover 2 is preferably corresponding to the base 1 so that the edge of small upper cover 2 is flush with that of base 1. An empty space is formed on the small upper cover 2 to constitute a recess for accommodating the upper flap 11, and engaging pieces 211 are provided on the small upper cover 2 surrounding the border of recess 21 corresponding to the engaging pieces 111. The engaging pieces 211 shown in the embodiment illustrated in FIG. 1 are projections. Meanwhile, the small upper cover 2 is preferably made of high molecular material as an integral piece such that a tighter engagement can be reached due to the flexibility thereof.

The large upper cover 3 also has a shape of plate and the contour thereof is preferably corresponding to the outer diameter of large CD and an empty space on the large upper cover 3 is formed to constitute a large recess 31 corresponding to the upper flap 11. Engaging pieces 311 are provided on the large upper cover surrounding the border of large recess 31 for corresponding to the engaging pieces 111 on the upper flap 11. The engaging pieces 311 illustrated in the embodiment shown in FIG. 1 are projections. In fact, the engaging pieces 311 are the same as the engaging pieces 211 because both of engaging pieces 211, 311 are selectively used to engage with the engaging pieces 111 on the upper flap 11. Alternatively, the engaging pieces 111 can be arranged separately for corresponding to the engaging pieces 211 and the engaging pieces 311 respectively. The small upper cover 2 and the large upper cover 3 are preferably made of high molecular material as an integral piece.

The lower cover 4 has a size corresponding to the large upper cover 3 and a recess part 41 is formed to correspond to the base 1. Engaging pieces 42 are provided on the lower cover 4 at the border of recess part 41 to correspond to engaging pieces 12 on the base 1. As the preceding description, the lower cover 4 is preferably made of high molecular material as an integral piece and the thickness thereof is not less than that of the base 1.

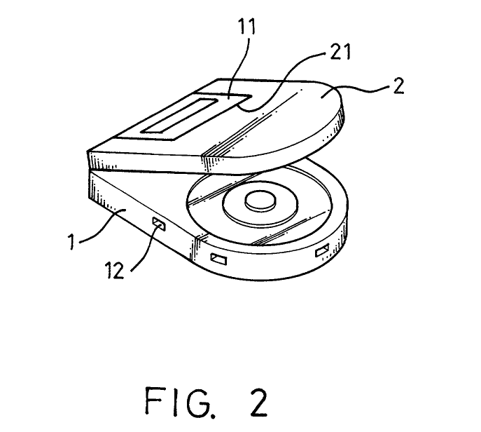

Referring to FIG. 2, the small upper cover 2 fits with the upper flap 11 by way of engaging pieces 211 engaging with engaging pieces 111 as soon as the small CD is going to be loaded on the CD walkman of the present invention. Hence, the small upper cover 2 can protect the small CD from foreign substances while an operation of loading the small CD is performed as shown in FIG. 2.

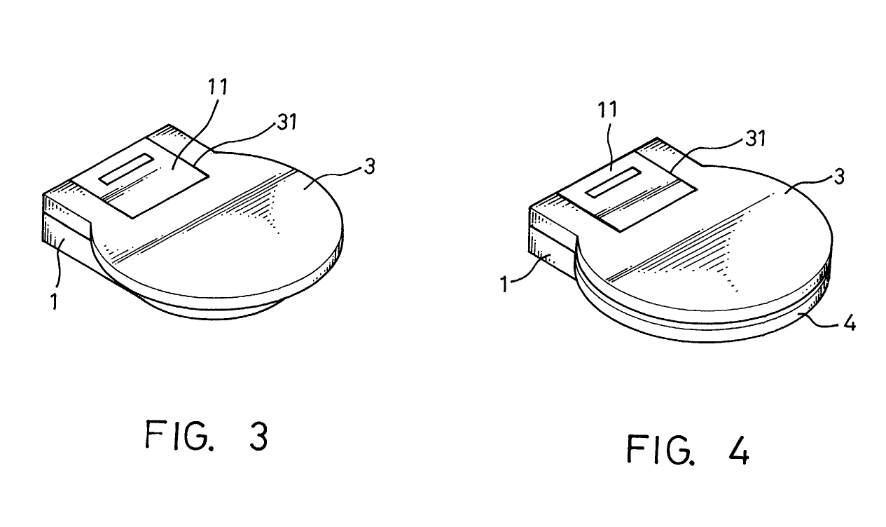

As soon as the large CD is going to be loaded, the small upper cover 2 is detached from the upper flap 11 first. Then, the large upper cover 3 is attached to the upper flap 11 by way of the engaging pieces 311 on the large upper cover 3 engaging with the engaging pieces 111 on the upper flap 11 instead. Thus, the large upper cover 3 can protect the large CD while the large CD is in operation as shown in FIG. 3. In addition, the lower cover 4 can fit with the base 1 by way of engaging pieces 42 on the lower cover 4 engaging with engaging pieces 12 on the base 1 to conceal the lower part of large CD as shown in FIG. 4.

It can be understood that the CD walkman adaptable for large and small CDs of the present invention provides a base feasible for being used commonly in case of large and small CDs being in operation respectively. It is appreciated that the present invention expands the scope of application for the CD walkman and prevents the large CD from leaving unused. Therefore, the present invention makes the resource possible be utilized effectively and this is unable to reach by way of the prior art CD walkman.

While the invention has been described with reference to preferred embodiment thereof, it is to be understood that modifications or variations may be easily made without departing from the spirit of this invention, which is defined by the appended claims.

What is claimed is:

1. A CD walkman adaptable for large and small compact disks, comprising
a base with a rear end, providing a reading and audio device therein, an upper flap being attached to an upper part of the rear end, and a plurality of engaging pieces being provided at an edge of the upper flap;
a small upper cover, having a size corresponding to the base, providing a first recess part corresponding to the upper flap, and a plurality of first engaging pieces being provided at a border surrounding the first recess part; and
a large upper cover, providing a second recess part corresponding to the upper flap, and a plurality of second engaging pieces being provided at a border surrounding the second recess part;
whereby, the first engaging pieces engaging with the engaging pieces on the upper flap makes the small upper cover as an upper protection for the small CD in operation; and the second engaging pieces engaging with the engaging pieces on the upper flap makes the large upper cover as an upper protection for the large CD in operation.

2. The CD walkman adaptable for large and small compact disks according to claim 1, wherein a plurality of engaging pieces are provided on an edge surrounding the base; a lower cover is provided to have a third recess part corresponding to the base with a plurality of third engaging pieces on a border surrounding the third recess part; and the third engaging pieces engaging with the engaging pieces on the base makes a lower protection for the large CD in operation.

3. The CD walkman adaptable for large and small compact disks according to claim 1, wherein the large upper cover and the small upper cover are made of high molecular material as an integral piece respectively.

4. The CD walkman adaptable for large and small compact disks according to claim 1, wherein the engaging pieces on the upper flap are grooves, and the first and the second engaging pieces are projection locks respectively.

5. The CD walkman adaptable for large and small compact disks according to claim 1, wherein the engaging pieces on the upper flap may be provided on the periphery thereof with two separate sections for engaging with the first and the second engaging pieces respectively.

6. The CD walkman adaptable for large and small compact disks according to claim 1, wherein the small upper cover preferably has a thickness corresponding to the thickness of the upper flap.

7. The CD walkman adaptable for large and small compact disks according to claim 1, wherein the lower cover preferably has a thickness not greater than the thickness of the base.

8. The CD walkman adaptable for large and small compact disks according to claim 1, wherein the upper flap has a shape of rectangle.
